(19) United States
(12) Patent Application Publication
(10) Pub. No.: US 2025/0005978 A1
(43) Pub. Date: Jan. 2, 2025

(54) Electronic Lock Wake System

(71) Applicant: Last Lock, Inc., Madison, WI (US)

(72) Inventors: Joseph O'Connell, Madison, WI (US); Alexander Mahnke, Madison, WI (US); Kari Hahn, Madison, WI (US); Jakob Landgraf, Madison, WI (US); Christian Schuster, Deerfield, WI (US)

(21) Appl. No.: 18/590,934

(22) Filed: Feb. 28, 2024

Related U.S. Application Data
(60) Provisional application No. 63/487,614, filed on Feb. 28, 2023.
(60) Provisional application No. 63/514,116, filed on Jul. 17, 2023.

(51) Int. Cl. G07C 9/00

(52) U.S. Cl. CPC G07C 9/00182; G07C 2009/0019; G07C 2009/0065; G07C 2009/00769

(57) ABSTRACT

The embodiments presented within provide methods, devices, and computer readable medium involving generation of power within a device, using this power to activate the device, measuring a physical characteristic of the power indicative of an external event, and then waking the device fully based on the external event. The device remains in a low-power sleep state until being woken based on the external event.

### FIELD

The present disclosure is directed to a lock system, specifically an electronic lock system. The present application claims priority to U.S. Provisional Application No. 63/487,614 filed Feb. 28, 2023, U.S. Provisional Application No. 63/514,116 filed Jul. 17, 2023, and U.S. Provisional Application No. 64/597,695 filed Nov. 9, 2023. The entire disclosures of these applications are incorporated herein by reference.

### BACKGROUND

Door locks are by far one of the most common security measures in both residential and commercial settings. The basic structure of locks has not changed in several hundred years. A user seeking to open a door inserts a key with an irregular, toothed shape into the lock. The teeth correspond to, and physically interact with, pins in the lock. If all of the pins are raised to the correct level by their corresponding key teeth, the user can disengage the locking mechanism. While this system has enjoyed widespread use, it does have limitations. Because only one configuration of teeth may open a given lock, if a key is lost, copied, or stolen, then the lock is no longer secure. Once that happens, the entire lock must be replaced or rekeyed, with new keys given to all users, a cumbersome and time consuming process. Because the lock is purely mechanical in nature, it does not create an entry record of who opened a door or when it was opened.

A physical lock face typically must be strong with a high hardness to endure malicious attacks. In some locks, this is achieved by adding small steel pieces to a brass lock face where it would be easy to drill and bypass. In other locks, the full face is made out of strong steel to be able to protect the entire face.

Electronic smart locks may lower the cost of rekeying cylinders and doors. Electronic locks with network connectivity may be remotely controlled. Lock access to individual users may be amended without need for physical access to the locks.

In regards to radio-frequency identification (RFID) locks, an electromagnetic signal is not able to pass through a plane of metal. As such, one common solution is to use a plastic face with the RFID reader with the locking mechanism attached on the inside of the door lock. If the plastic face is drilled through, the actual locking mechanism is not readily available. Some other locks use glass. One lock uses Gorilla Glass, a chemically strengthened glass developed by Corning. Glass is amorphous and progressively softens under heat.

Users have attempted to solve these problems through the use of electronic locks, which require a token, code, biometric input, or other unique identifier to open. Because these systems are electronic, they require a power source, such as line power or batteries. If the lock's batteries run out or it is cut off from power lines, then the lock becomes useless. Locks must have excellent network connection capabilities while simultaneously using miniscule amounts of energy to maximize battery life. A combination lock may have its code given out to other unauthorized users. A keycard for a lock may get confused with other cards or lost. Furthermore, the locks do not fit conventional door knobs and must be specially installed.

There is an unmet need in the art for an electronic lock system that can be retrofitted to existing doors and lock systems and that solves the problems above.

### SUMMARY

The embodiments presented within provide methods, devices, systems, and computer readable medium that improve access control through the use of locks. Some embodiments presented include mortise and key-in-knob form-factor locks.

In one embodiment, a method of waking an electronic device is disclosed. The electronic device generates a unit of power in a power unit. The electronic device may be powered with the unit of power. A physical characteristic of an output of the power unit may be measured in a power condition reading device wherein the physical characteristic reflects an external event that affected the output of the power unit. The electronic device may be waked based on the physical characteristic.

In another embodiment, the electronic device may be an electronic lock.

In another embodiment, the power unit may be a solar cell.

In another embodiment, the physical characteristic may be one or more of a voltage level and a current level.

In another embodiment, the external event may be one or more of a moving object, a fire alarm, a lightning storm, a change in an ambient lighting condition, and a person loitering near the electronic device.

In another embodiment, a radio transceiver may be activated to detect a presence of an antenna near the electronic device, and the electronic device may wake based on the physical characteristic and the presence of the antenna.

In another embodiment, the unit of power may be stored in an energy storage component.

In another embodiment, a switch controlled by an output of a processor may select whether to power the electronic device with the unit of power or measuring the physical characteristic of the output of the power unit in the power condition reading device.

In another embodiment, a measurement of the physical characteristic may be stored in a buffer of samples.

In another embodiment, the buffer of samples may be passed through a low pass filter.

In another embodiment, the measurement of the physical characteristic may be compared to a mean value of the buffer of samples.

In another embodiment, a standard deviation may be calculated for the buffer of samples and waking the electronic device when the standard deviation for the buffer of samples is outside a threshold.

In another embodiment, a machine learning based filter may be applied to the buffer of samples to detect one or more of a person moving toward the electronic device, a person moving away from the electronic device, a person moving past the electronic device, a change in lighting near the device.

In another embodiment, a remote entity may be alerted based on the physical characteristic.

The presented embodiments may be represented in methods, devices, systems, or in computer readable media containing instructions to implement the methods.

### BRIEF DESCRIPTION OF THE DRAWINGS

FIG. 1 is an illustration of one embodiment of a smart cylinder 100 with a bi-stable spring loaded clutch 102.

FIG. 2a is an illustration of an exploded view of an embodiment of a bi-stable spring loaded clutch 200.

FIG. 2b is an illustration of an exploded view of torque transferring components of an embodiment of a bi-stable spring loaded clutch 200.

FIG. 3 is an illustration of one embodiment of a bi-stable spring loaded clutch 300 from a side profile where the clutch is uncoupled.

FIG. 4 is an illustration of an embodiment of a bi-stable spring loaded clutch 400 from a side profile where the clutch is coupled.

FIG. 5 is an illustration of other embodiments of a bi-stable spring loaded clutch including bidirectional bi-stable spring loaded clutch 500 and unidirectional bi-stable spring loaded clutch 502.

FIG. 6a is an illustration of a mortise smart cylinder 600 with bi-stable spring loaded clutch 602.

FIG. 6b is an illustration of a euro smart cylinder 604 with bi-stable spring loaded clutch 606.

FIG. 6c is an illustration of a rim smart cylinder 604 with bi-stable spring loaded clutch 610.

FIG. 7 is an illustration of a general form smart cylinder 700 with bi-stable spring loaded clutch 702.

FIG. 8 is an illustration of a complete smart cylinder 800 with user interface 802, mortise body 804, front plate 806, and lighted display ring 808.

FIG. 9 is an illustration of a side view of a complete smart cylinder 900 with user interface 902, mortise body 904, and lock cam 906.

FIG. 10 is an illustration of a top view of a complete smart cylinder 1000 with user interface 1002, mortise body 1004, and lock cam 1006.

FIG. 11 is an illustration of one embodiment of a hardware block diagram for a solar wake feature 1100.

FIG. 12 is an illustration of another embodiment of a hardware block diagram for a solar wake feature.

FIG. 13 is an illustration of flow chart which depicts some elements of a solar wake feature as implemented on a device.

FIG. 14 is an illustration of a hallway where an angle of arrival estimate would be useful.

FIG. 15 is an illustration of an electronic lock system 1500 determining the angle of arrival of a user device 1502.

FIG. 16 illustrates two views of a configuration where an electronic lock system interacts with three UWB nodes in a multi-node beacon detection system.

FIG. 17 is an illustration of a use case for a UWB enabled electronic lock system where a hand motion unlocks the UWB enabled electronic lock system.

FIG. 18 is an illustration of the architecture of one possible implementation of a gesture detecting electronic lock system 1800.

FIG. 19 is an illustration showing implementation details of a gesture based electronic lock control 1900.

FIG. 20 is an illustration of the received signal from a UWB radar receiver when a single object passes through the UWB radar view.

FIG. 21 is an illustration of the received signal from a UWB radar receiver when a single object passes through the UWB radar view.

### DETAILED DESCRIPTION

Representative embodiments are described below with reference to the accompanying drawings. It should be understood that the following description is intended to describe representative embodiments, and not to limit the appended claims. In the present description, certain terms have been used for brevity, clearness, and understanding. No unnecessary limitations are to be applied there from beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

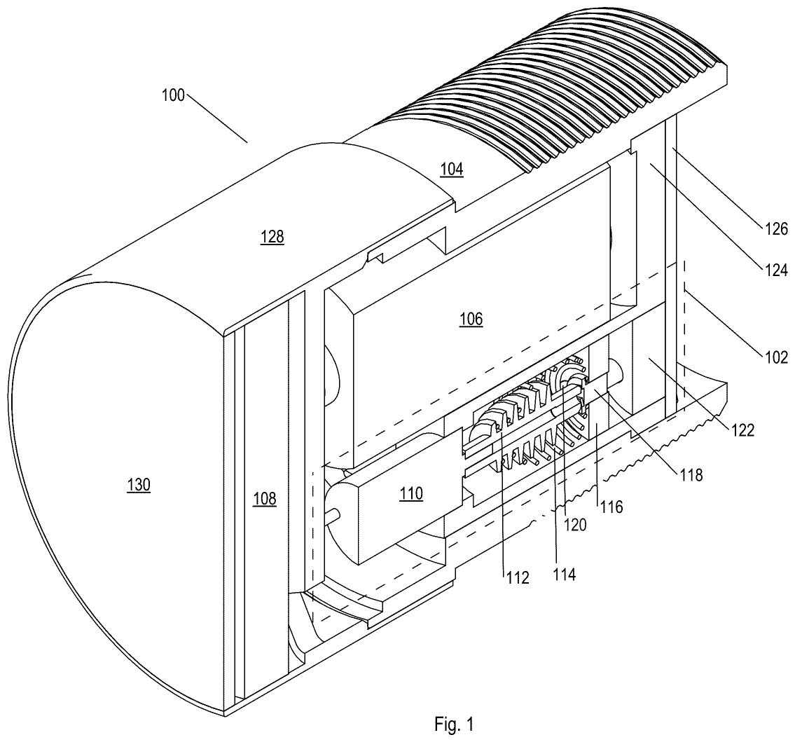

FIG. 1 is an illustration of one embodiment of a smart cylinder 100 with a bi-stable spring loaded clutch 102. A smart cylinder 100, which is a component in an electronic lock or other access control device, has two stable states, an unlocked position and a locked position which are mediated by the bi-stable spring loaded clutch 102. Smart cylinder 100 comprises housing 104, power unit 106, control interface 108, motor 110, tapered lead screw 112, egg spring 114, clutch pin holder 116, spring mounting screw 118, clutch pin 120, pin housing 122, interior housing 124, clutch engagement member 126, and user interface 128. The elements of the bi-stable spring loaded clutch 102 are further described in figures herein. Power unit 106 provides power to control interface 108. When an unlock action is authorized, control interface 108 energizes motor 110. Motor 110 engages the mechanism of the bi-stable spring loaded clutch 102 as further described in figures herein. Briefly, motor 110 drives tapered lead screw 112 which compresses egg spring 114. Optionally, tapered lead screw 112 may be created with no taper for simplicity of design. Egg spring 114 may be shaped like an egg to aid in letting one part of the egg spring 114 travel on the tapered lead screw 112 and one part of the egg spring 114 compress or extend to provide tension. The compressive force on egg spring 114 drives clutch pin 120 (second clutch pin 120 not shown in this cut-away drawing) which are held by clutch pin holder 116. Clutch pin 120 interfaces into pin housing 122 and clutch engagement member 126. Pin housing 122 connects to interior housing 124 which connects to user interface 128 allowing the user to spin the entire smart cylinder without changing locking mechanism when the clutch is not engaged. User interface 128 allows a user to actuate the lock when clutch engagement member 126 has clutch pin 120 seated. When clutch is not engaged, User interface 128 spins freely without turning clutch engagement member 126.

Tapered lead screw 112 and egg spring 114 are designed to mate in such a way that the egg spring 114 can be compressed by the tapered lead screw 112 and to also transfer the compressive force to the pin housing 122 and clutch pins 120. As a non-limiting example, one possible description of the arc of an egg spring can be described by the following formula:

f(x)={3.8208x3−3.8972x2+4.6869x−6.3183*10−2,x∈[0.34,0.44]−1.6612x3+3.3391x2+1.5029x−4.038*10−2,x∈(0.44,0.67]

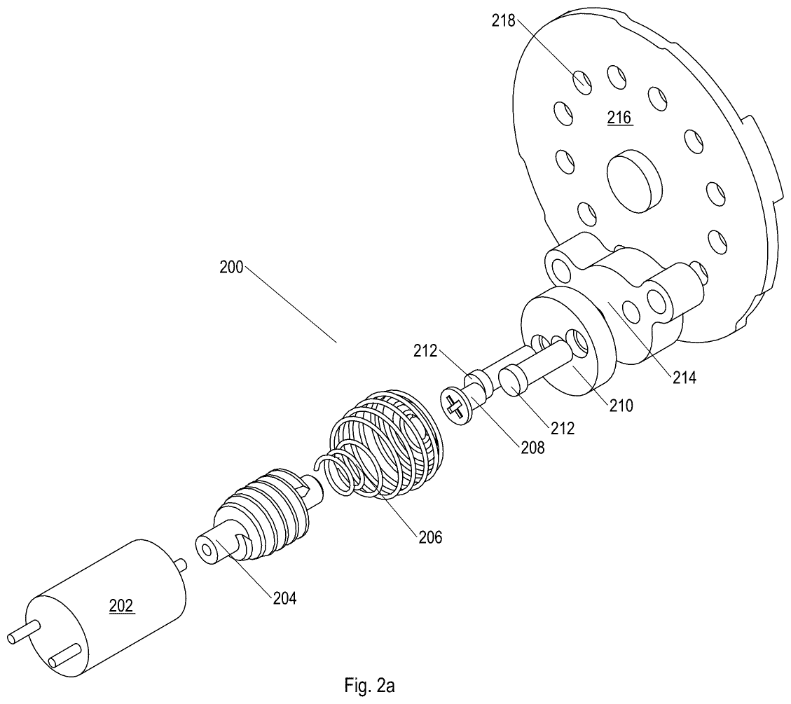

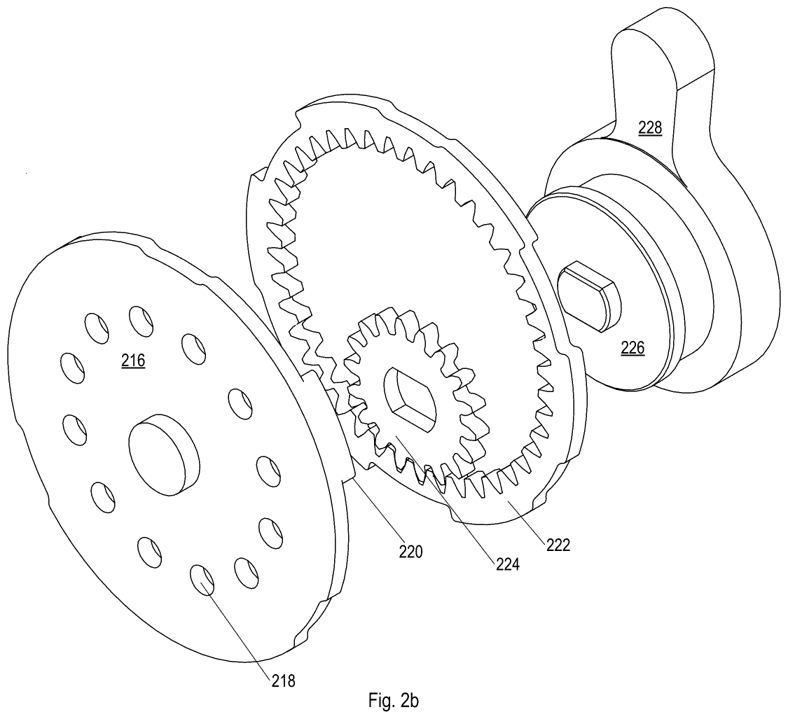

FIG. 2a is an illustration of an exploded view of an embodiment of a bi-stable spring loaded clutch 200. Bi-stable spring loaded clutch 200 comprises motor 202, tapered lead screw 204, egg spring 206, spring mounting screw 208, clutch pin holder 210, clutch pins 212, pin housing 214, clutch engagement member 216, and clutch pin holes 218. The bi-stable spring loaded clutch 200 is operated by motor 202 which may be a direct-current (DC) motor or other device capable of actuating the mechanism. In one embodiment, motor 202 turns tapered lead screw 204 which may be a helical, tapered lead screw. In another embodiment, the tapered lead screw 204 may be a worm gear with rotational compression action. The tapered lead screw 204 teeth operatively engage with egg spring 206. In one embodiment, the pitch of tapered lead screw 204 teeth may be the same as the pitch of the coils of egg spring 206. In one embodiment, the teeth of tapered lead screw 204 are threadedly engaged with egg spring 206. In an embodiment, egg spring 206 is restrained from rotation due to spring mounting screw 208. In another embodiment, egg spring 206 may be fixed from rotation with different engagement members such as, for example but not limited to, pins or tabs.

Powering motor 202 may create linear motion of the egg spring 206 because rotation may be restricted. In an embodiment, there are no hard limits on the linear travel of egg spring 206 since the coils of egg spring 206 will disengage from the teeth of tapered lead screw 204 without binding. Thus, with no hard limits, motor 202 may spin freely without causing a current spike that may occur when the motor stalls during operation. This leads to very low power consumption in the system and eliminates the need for sensors or sensing techniques to determine the state of the bi-stable spring loaded clutch 200. Motor 202 may operate at sufficient speed that a very short operation will ensure adequate travel along tapered lead screw 204 since current spikes are minimized. In one embodiment, motor 202 may be operated with a sine wave drive and controller. In another embodiment, motor 202 may be operated with a pulse width modulated motor controller. Motor control may allow for precise position control and minimal actuation time. In so doing, multiple states of drive location can be achieved.

FIG. 2b is an illustration of an exploded view of torque transferring components of an embodiment of a bi-stable spring loaded clutch 200. Clutch engagement member 216 and clutch pin holes 218 are repeated from the figure above. In one embodiment, keying feature 220 of clutch engagement member 216 connects to matching keying feature 221 of internal spur gear 222 which engages external spur gear 224. External spur gear 224 drives gear shaft 226 with cam 228.

Clutch pins 212 are inserted into clutch pin holder 210. Linear travel of the coils of egg spring 206 along tapered lead screw 204 causes a compression force on clutch pins 212. The compression force is generated, at least in part, by egg spring 206 being restrained from traveling back along tapered lead screw 204. In one embodiment, clutch pins 212 are pushed through pin housing 214 into clutch pin holes 218. If torque transferring elements such as clutch pins 212 are not aligned at the time of actuation, compressive spring force from egg spring 206 allows the pieces to align during rotation of the torque transmitting members. The length of the pin allows for torque to transfer from pin housing 214 to clutch engagement member 216 without stressing clutch pin holder 210. In other embodiments, different blocking members other than clutch pins 212 can be pushed onto alternatively designed clutch engagement member 216. In one embodiment, internal spur gear 222 and external spur gear 224 translate the rotational axis from the center of the lock to the center of the cam 228 to operate door hardware. This embodiment allows for bidirectional transmission of torque from pin housing 214 to clutch engagement member 216. Other torque transferring mechanisms are discussed herein.

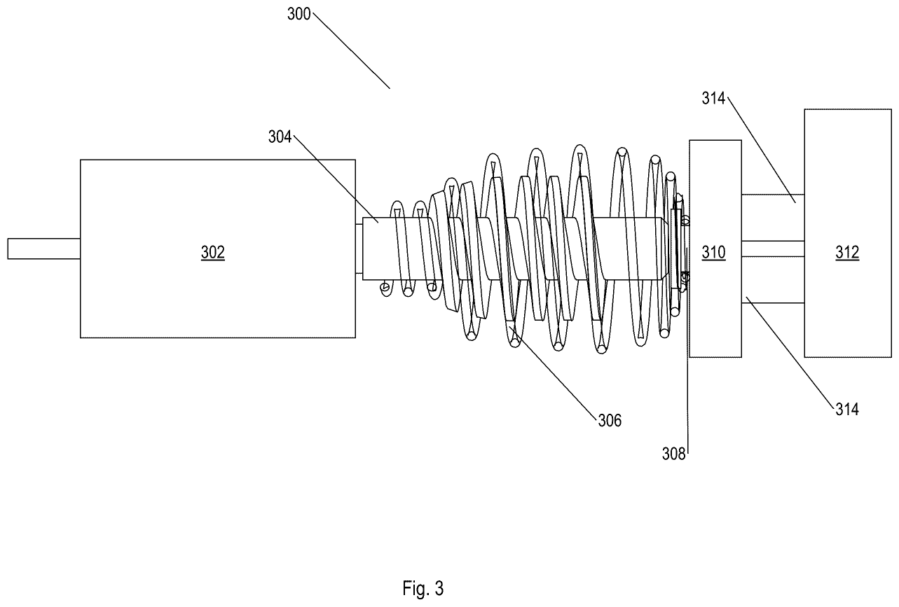

FIG. 3 is an illustration of one embodiment of a bi-stable spring loaded clutch 300 from a side profile where the clutch is uncoupled. Bi-stable spring loaded clutch 300 comprises motor 302, tapered lead screw 304, egg spring 306, spring mounting screw 308, clutch pin holder 310, pin housing 312, and clutch pins 314. In FIG. 3, egg spring 306 is position back on tapered lead screw 304 drawing clutch pin holder 310 and clutch pins 314 back with it. Therefore, clutch pins 314 do not penetrate past pin housing 312 into a clutch engagement member, so the clutch is disengaged. When a user turns the lock, the entire bi-stable spring loaded clutch 300 spins freely and separately from a clutch engagement member.

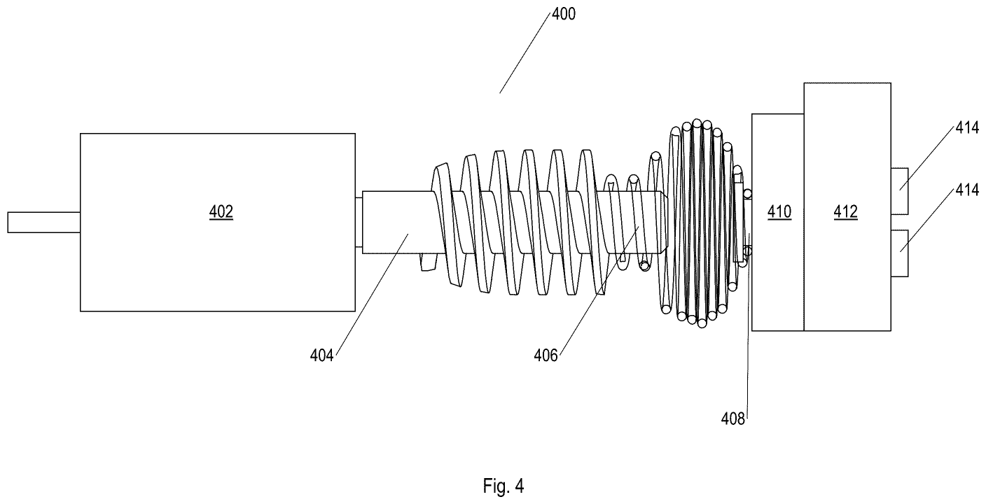

FIG. 4 is an illustration of an embodiment of a bi-stable spring loaded clutch 400 from a side profile where the clutch is coupled. Bi-stable spring loaded clutch 400 comprises motor 402, tapered lead screw 404, egg spring 406, spring mounting screw 408, clutch pin holder 410, pin housing 412, and clutch pins 414. In FIG. 4, egg spring 306 is compressed, pushing clutch pin holder 410 up against pin housing 412 and causing clutch pins 414 to penetrate pin housing 412 such that they may engage the clutch engagement members shown and discussed in FIG. 2b.

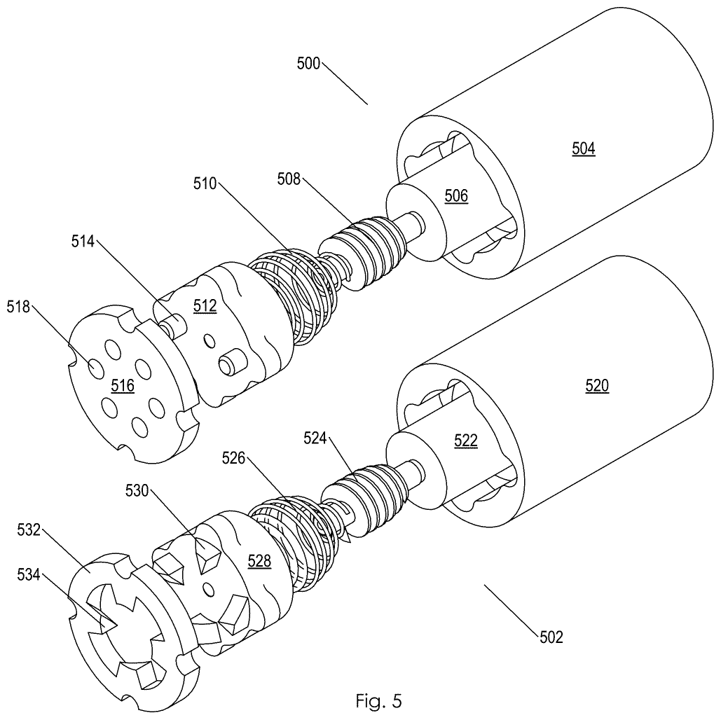

FIG. 5 is an illustration of other embodiments of a bi-stable spring loaded clutch including bidirectional bi-stable spring loaded clutch 500 and unidirectional bi-stable spring loaded clutch 502. Bidirectional bi-stable spring loaded clutch 500 comprises housing 504, motor 506, tapered lead screw 508, egg spring 510, housing 512 with keyed pins 514, and clutch engagement plate 516 with pin holes 518. Keyed pins 514 transfers force to clutch engagement plate 516 no matter which direction housing 512 is turned.

The mechanism of bi-stable spring loaded clutch 502 allows for unidirectional transmission of torque and lets a system be designed that allows a user to only engage a deadbolt or latch but not be able to retract the deadbolt or latch without a different credential. Unidirectional bi-stable spring loaded clutch 502 comprises housing 520, motor 522, tapered lead screw 524, egg spring 526, housing 528 with tapered dog teeth 530, and clutch engagement plate 532 with mating dog teeth 534. Tapered dog teeth 530 transfers force to mating dog teeth 534 only while housing 528 is turned counter-clockwise. When housing 528 is turned clockwise, the tapered dog teeth 530 ride up on the mating dog teeth 534 because of the tapered slope. In this embodiment, spring tension given by egg spring 526 is insufficient keep housing 528 engaged with clutch engagement plate 532. In other embodiments, spring tension given by egg spring 526 can be increased until friction between tapered dog teeth 530 and mating dog teeth 534 reaches a point where housing 528 is locked to clutch engagement plate 532, regardless of direction of rotation. In this embodiment, motor 522 can be set to three positions: disengaged where the egg spring 526 rides back on tapered lead screw 524, engaged for bidirectional motion where egg spring 526 is put under sufficient compression to lock tapered dog teeth 530 and mating dog teeth 534 no matter the direction of rotation, and engaged for counter-clockwise motion only where the egg spring 526 is put under sufficient compression to engage tapered dog teeth 530 with mating dog teeth 534 but not enough compression to remain locked while rotating clockwise.

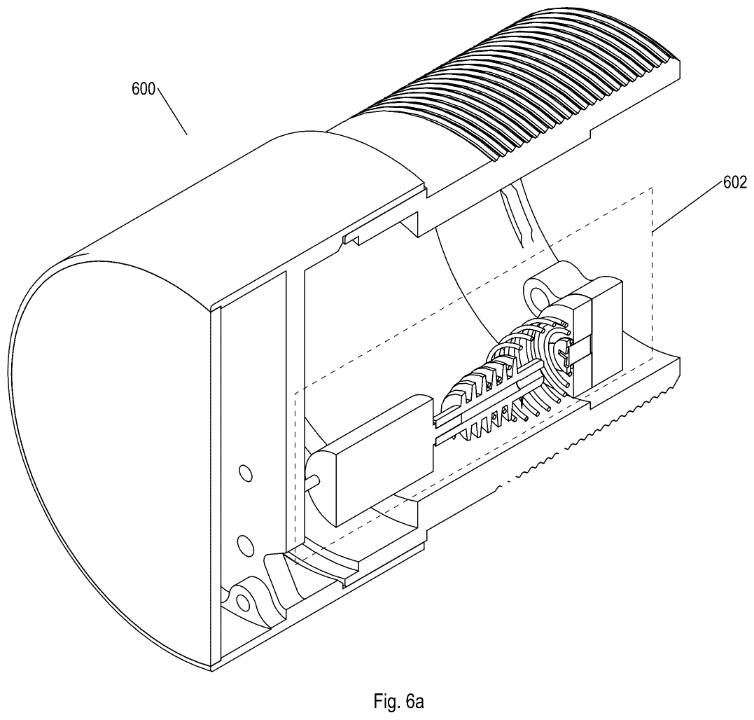

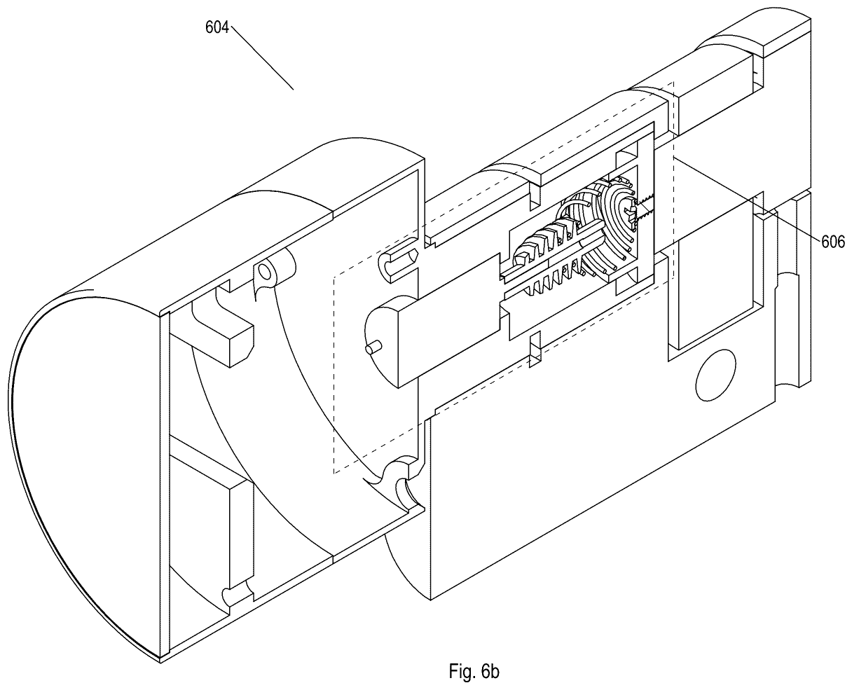

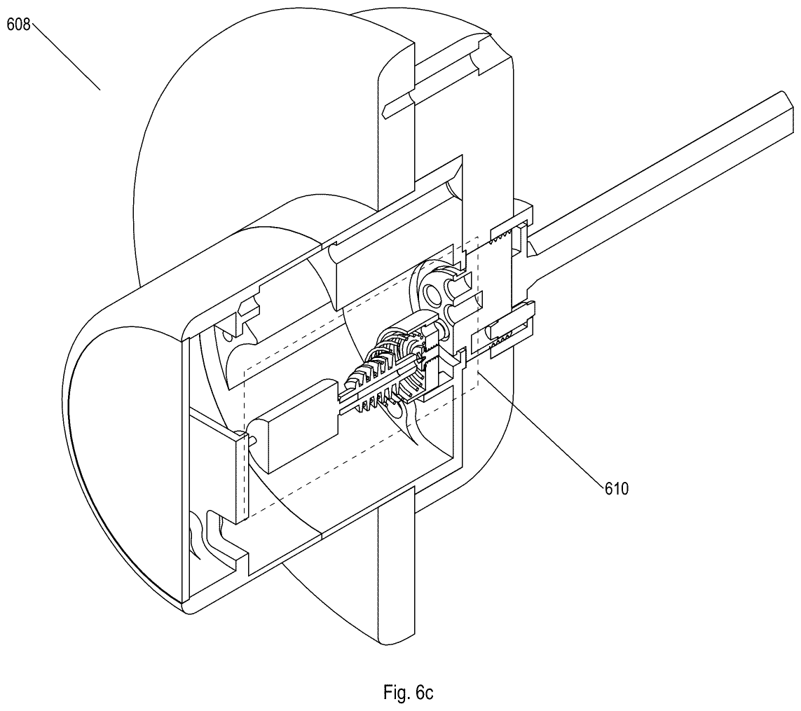

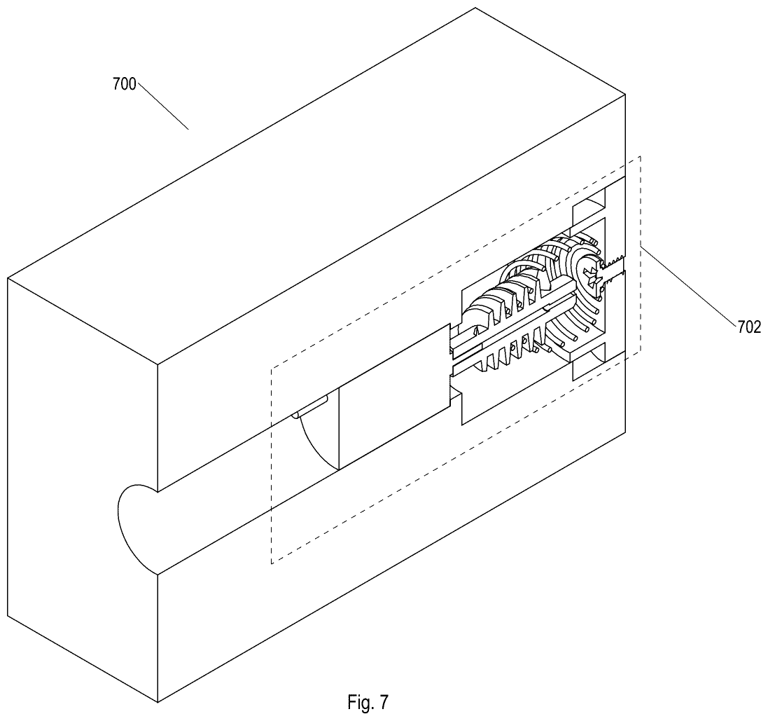

FIG. 6a is an illustration of a mortise smart cylinder 600 with bi-stable spring loaded clutch 602. FIG. 6b is an illustration of a euro smart cylinder 604 with bi-stable spring loaded clutch 606. FIG. 6c is an illustration of a rim smart cylinder 608 with bi-stable spring loaded clutch 610. More generally, FIG. 7 is an illustration of a general form smart cylinder 700 with bi-stable spring loaded clutch 702.

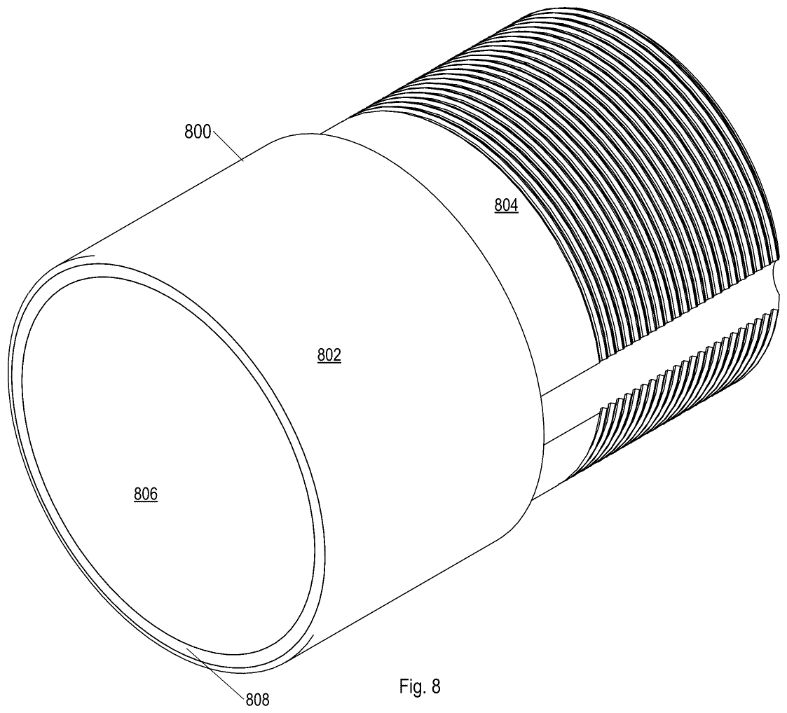

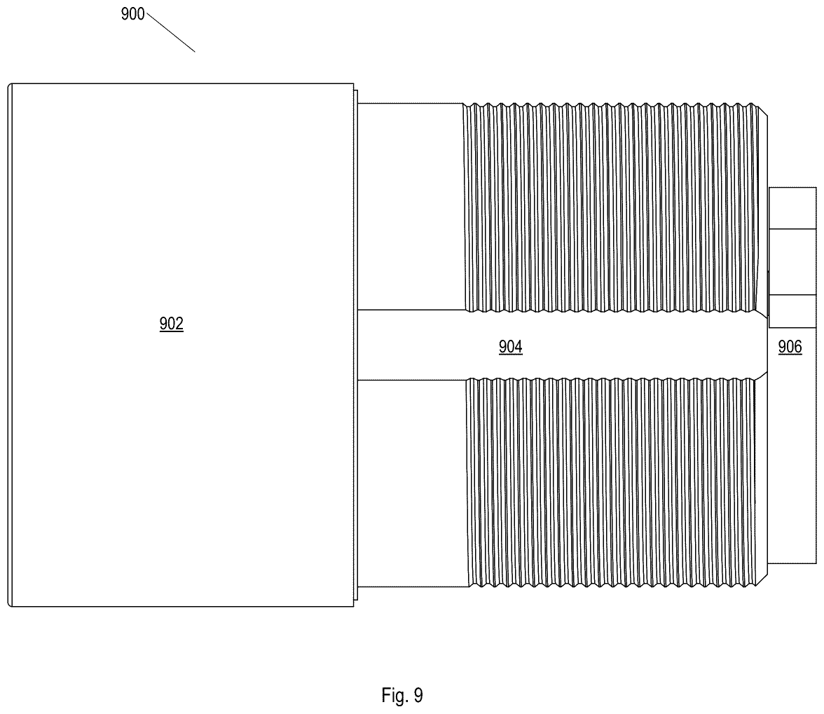

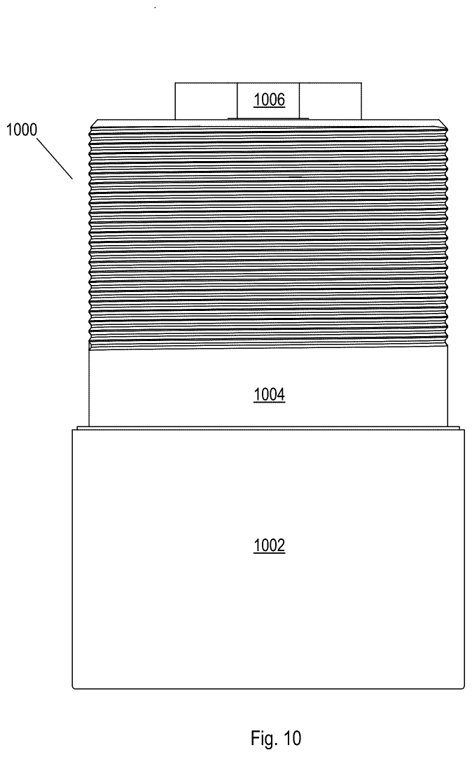

FIG. 8 is an illustration of a complete smart cylinder 800 with user interface 802, mortise body 804, front plate 806, and lighted display ring 808. FIG. 9 is an illustration of a side view of a complete smart cylinder 900 with user interface 902, mortise body 904, and lock cam 906. FIG. 10 is an illustration of a top view of a complete smart cylinder 1000 with user interface 1002, mortise body 1004, and lock cam 1006.

### *Solar Wake Feature

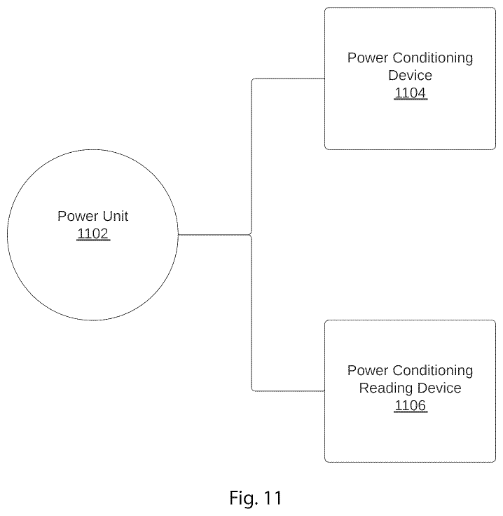

FIG. 11 is an illustration of one embodiment of a hardware block diagram for a solar wake feature 1100 implemented on a device. Power unit 1102 generally provides power used by the device. The device may be an electronic lock or any other powered device. Power unit 1102 may be a solar cell or some other power generation hardware where power produced is a function of a physical state. The device remains in a low-power sleep state as much as possible in order to conserve power provided by power unit 1102. Power conditioning device 1104 converts power generated by power unit 1102 into a usable form by other parts of the device. In some embodiments, power conditioning device 1104 uses produced power to charge batteries, capacitors, other energy storage components, or to otherwise operate the device. A power condition reading device 1106 monitors the power produced. Power conditioning reading device 1106 may monitor voltage, current, or other physical characteristics of power unit 1102 potentially including the power generated by power unit 1102. In some embodiments, power condition reading device 1106 may be a general purpose input and output (GPIO) from a controller. In other embodiments, an analog-to-digital converter (ADC) may monitor the power produced. When the power condition reading device 1106 detects a change in the power produced, the power condition reading device 1106 issues a command to the rest of the device to wake the device up from sleep. The command may optionally be issued through a control unit. The change in the power produced reflects an external event that affected the steady-state power produced as further discussed herein.

In one embodiment, power unit 1102 comprises a solar cell, power conditioning device 1104 comprises a power harvester, and power condition reading device 1106 comprises a GPIO set to read the analog voltage of the wire providing power to the power harvester. A solar wake process can be used to detect the presence of a moving object in front of the power unit 1102. In one embodiment of a lock application, a human being can be detected as they approach or are present in front of the lock. In another embodiment, an object like a key card can be detected when a user holds it over the power unit 1102. In another embodiment, power unit 1102 may generate power by electromagnetic means and interference with that generation may be detected. By using a solar wake process, power necessary for presence detection is minimized and component count is minimized as no other sensors are required.

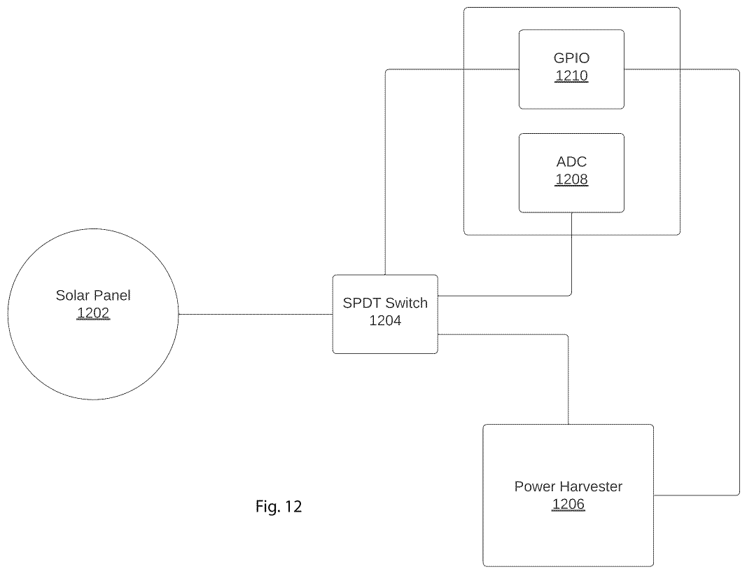

FIG. 12 is an illustration of another embodiment of a hardware block diagram for a solar wake feature. Solar panel 1202 is connected to single pole, double throw switch (SPDT) 1204. Outputs of SPDT 1204 are routed to power harvester 1206 and to analog to digital converter (ADC) 1208. SPDT 1204 switch state is selected by GPIO 1210. Thus, the embodiment either routes power to the power harvester 1206 for powering the device or routes power to the ADC 1208 for measurements for solar wake. SPDT 1204 may isolate the unselected route. This embodiment allows power harvester 1206 to draw down the voltage off the solar panel 1202 without affecting measurements. When measurements are completed quickly, there is minimal impact on the amount of power the system can produce. In alternative embodiments, a single pole, single throw switch (SPST) may be used instead of SPDT 1204.

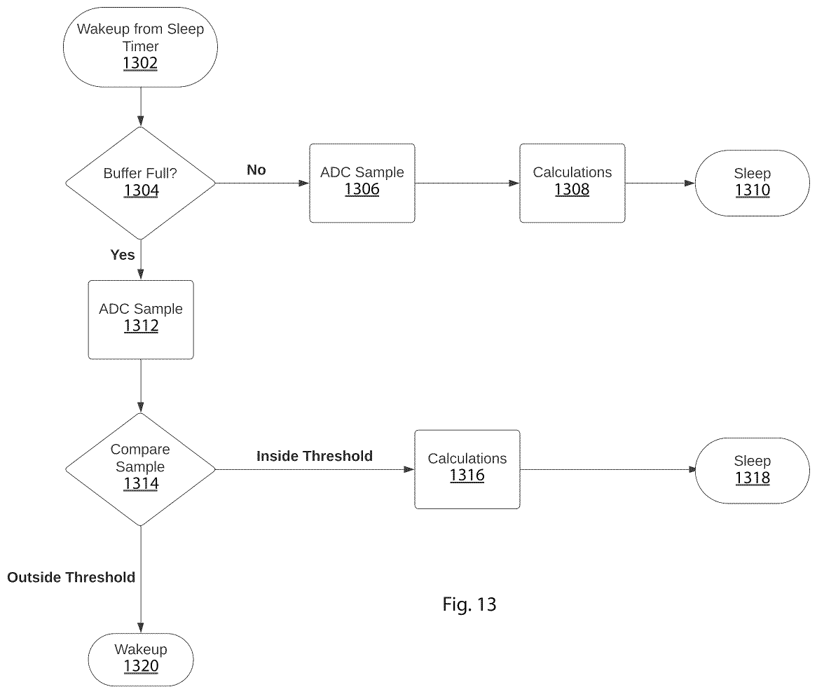

FIG. 13 is an illustration of flow chart which depicts some elements of a solar wake feature as implemented on a device. In step 1302, the device wakes from sleep. In step 1304, the device determines if a buffer of samples is full. If it is not, in step 1306, an ADC is used to measure a voltage on a solar panel. In step 1308, calculations are performed and the ADC result is put into the buffer. Then, in step 1310, the device is put back to sleep with a timer. In step 1304, if the buffer is full, control moves to step 1312 where a new ADC measurement is made. In step 1314, the ADC value is compared with the buffer. If the measured value is within a threshold, in step 1316, calculations are performed and the result is put into the buffer. In step 1318, the device is put back to sleep with a timer. If the ADC value in step 1314 is found to be outside of the threshold, then in step 1320, the device is woken up. In an embodiment where the device is a lock, the lock begins to look for credentials. The calculations in step 1308 and step 1316 are further described herein.

In step 1306 and step 1312, ADC samples are taken. To take an ADC sample, SPDT 1204 may be switched to route power to the ADC 1208. The device may then trigger the signal digitization in ADC 1208. When the signal is digitized, SPDT 1204 may be switched to route power back to power harvester 1206. Multiple samples may be taken before the voltage from solar panel 1202 has settled. The device may calculate the final voltage based on multiple samples.

In step 1308 and step 1326, calculations are performed on the read ADC value in order to improve the solar wake feature. First, read values may be passed through a low pass filter to minimize the effects of noise. The strength of the low pass filter may be set by a calibration routine or a default strength may be assigned from manual testing. In step 1326, the complete buffer is available which can allow for more complicated time based detection algorithms. A running average is simple to calculate and can cover many wake cases.

In step 1314, the ADC values are checked to determine if the device should be woken up. A simple comparison with a threshold may work in simple situations. An alternative embodiment allows a difference between two or more readings to be compared against a threshold to compensate for any lighting condition. The thresholds may be determined through a calibration routine or a default threshold may be assigned from manual testing. In some embodiments, a comparison that is above a light threshold may be used to increment an activity counter. When a comparison is below the threshold, the activity counter is decremented. The activity counter may be compared to a predetermined activity threshold to make the decision to wake the device. This embodiment allows for noisy signals or rejection of events like light switches being turned off.

Alternative algorithms are possible to implement solar wake. In the method described above, a buffer may be filled with ADC values from the solar panel. Between each ADC sample there is a small sleep period. The mean value of the buffer dataset is updated. Within the main loop, an ADC sample is collected and compared against the mean value of the buffer data. If the value is outside a defined threshold compared to the mean, the device wakes up and scans for key credentials. If the value is inside the threshold, the processor does not wake up, the buffer's mean value is updated, and the system sleeps until the next ADC sample time.

In another algorithm, a standard deviation is calculated on the buffer, in addition to the mean. Within the main loop, an ADC sample is compared against the mean value of the buffer dataset. If the value is outside of a threshold defined as a multiplier times the standard deviation of the dataset, the device wakes up and scans for key credentials.

In another algorithm, an ADC sample is included in the buffer dataset and a new standard deviation is calculated. When the standard deviation is outside a preset constant value, the device wakes up and continues as above.

In another algorithm, detection can be used for more than just binary detection of a person or object. With calibration and a machine learning based filter applied to the buffered data, it is possible to detect the behavior of a target. Some examples include, but are not limited to: detecting if a person is moving past the device, detecting if a person is moving toward the device, detecting if a person is moving away from the device, detecting when lights are turned on near the device, detecting when a credential is in front of the device, detecting flashing lights indicating specifically identifiable events like a flashing fire alarm, lightning storm, ambient lighting changes, or detecting a potential bad actor loitering near the device. These detected events may trigger decisions to enable and start scanning for credentials when warranted. In other situations, the lock can alert administrators or other remote entities based on which event is detected. In other embodiments, the detected events may trigger further detection processes to confirm a credential is being presented before waking the device. For example, a radio transceiver may be activated to detect the presence of a corresponding antenna of a credential before waking the device to begin communication with the credential. The algorithm can be further optimized to reduce power consumption and sampling rate during inactive times. Some examples include, but are not limited to: remaining inactive longer when installed on a single person office and there is someone in the office, remaining inactive longer outside of business hours, and generally matching polling frequency with other indicia that suggest more or less polling is warranted.

### *UWB—Proximity Unlocking Using Angle of Arrival Estimate

In electronic lock systems such as those described herein, there exist situations where it is useful to be able to distinguish various entities and actions that occur in front of the electronic lock system. As a non-limiting example, a lock that can distinguish between a user passing by and a user approaching and stopping at the lock can begin authentication processes sooner and therefore be more responsive. Multiple technologies may be used to implement these features. One possible technology is Ultra-wideband (UWB).

The ability of UWB to provide accurate direction measurements gives an electronic lock system the ability to calculate the angle of arrival of an object and determine intent of the holder of the object. An electronic lock system implementing the method described can be configured with a proximity requirement and a field of view requirement. Then, the electronic lock system can be set to only unlock when the object is within the set field of view and the set proximity. This technique allows for large scale lock deployments in cramped spaces and corridors, where multiple people have ranging sessions with multiple UWB devices. The system described herein allows an electronic lock to determine intent of the object approaching.

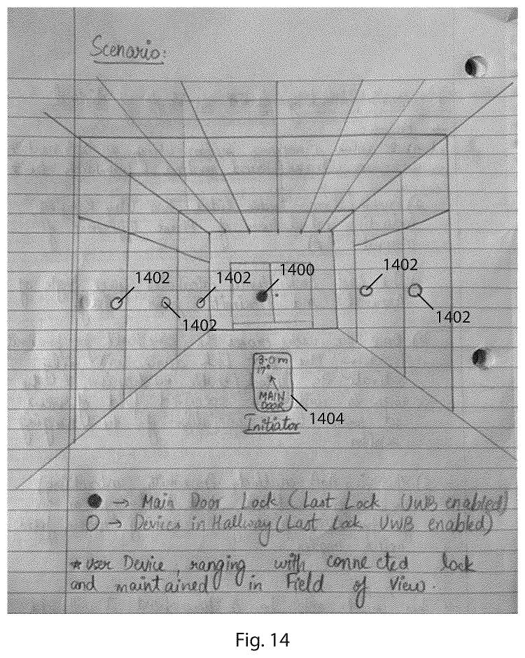

FIG. 14 is an illustration of a hallway where an angle of arrival estimate would be useful. Object electronic lock system 1400 and other electronic lock systems 1402 all line a crowded hallway. User device 1404 is approaching object electronic lock system 1400. The present method allows object electronic lock system 1400 to determine that user device 1404 intends to activate that particular electronic lock system and not any of the other electronic lock systems 1402.

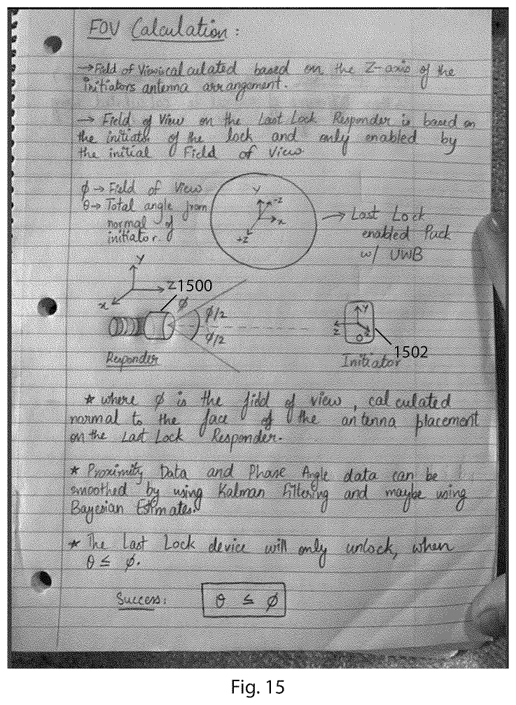

FIG. 15 is an illustration of an electronic lock system 1500 determining the angle of arrival of a user device 1502. The electronic lock system 1500 may wake up based on a solar wake feature as described herein. Other methods of waking up the lock are possible. The electronic lock system may use a bi-stable spring loaded clutch as described herein. Other activating systems are possible as well. The methods described may be used locking or unlocking or for asset or user tracking. The methods described may be implemented on multiple locks that communicate which each other to get better ranging and angle of arrival determinations.

In one instance of the system, the process begins by establishing a ranging session using an out-of-band (OOB) mechanism with a UWB enabled electronic lock system. Multiple out-of-band communication methods are possible. One possible method would be to communicate ranging parameters through Bluetooth Low Energy (BLE). Next, a Double Sided Two-Way Ranging (DS-TWR) session is started that includes a calculation of the phase difference of arrival, Δϕ. Angle of Arrival (θ) can then be calculated from the phase difference at the antennae (Δϕ), the wavelength (λ), and the distance between the antennae (d): θ=sin⁻¹((λΔϕ)/(−2πd)). Other ranging sessions and methods of calculating Angle of Arrival are possible. The DS-TWR session can also determine distance (proximity) between the electronic lock system and a user's authentication device. Proximity data, phase difference, and angle of arrival may be smoothed using Kalman filtering and potentially Bayesian estimates. The electronic lock system can now be set to unlock only when a device authenticates while the device is determined to be within a set threshold of proximity and a set threshold of Angle of Arrival.

### *UWB—Multi-Node Beacon Detection

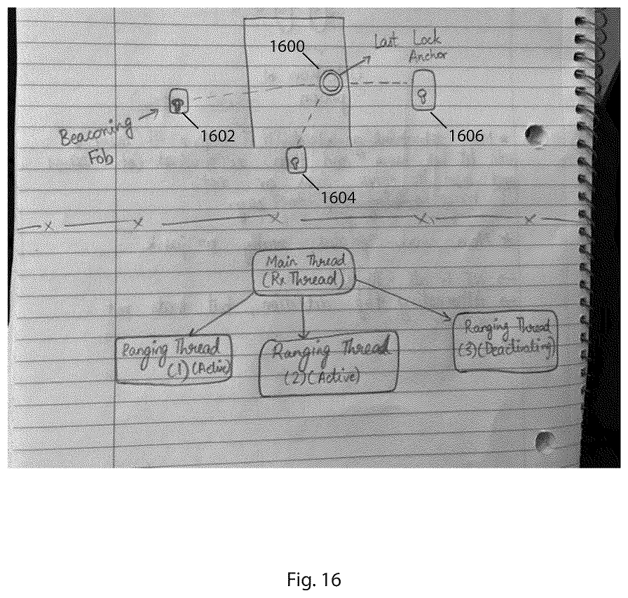

FIG. 16 illustrates two views of a configuration where an electronic lock system interacts with three UWB nodes in a multi-node beacon detection system. The electronic lock system 1600 acts as an anchor in the UWB system. Multiple electronic lock systems may each be configured in a lock system to act as anchors to improve location finding. The lock system may have other anchors that are not electronic lock systems. In addition, the lock system has a number of UWB nodes that may communicate with the lock system using UWB, BLE, or other communication systems. First UWB node 1602, second UWB node 1604, and third UWB node 1606 may be detected before authentication can occur. The system presented herein may be dynamically expanded to handle more UWB nodes or shrunk for fewer. Any UWB node may beacon or range with the electronic lock system 1600.

In one non-limiting example, multiple nodes send out beacon frames based on the IEEE 802.14.z specification. The lock system detects and handles the beacon frames. One method of communication for such a lock system is a Wireless Personal Area Network (WPAN) which is similar to larger area Wi-Fi networks. As described herein, we may improve on the UWB anchor through multiple processes. Among those processes and further described herein, we may alternate which anchor is active, each anchor may store node frames in an active tag stack, threads may be created to handle each ranging session, and a life cycle of threads may be maintained for connected UWB nodes or tags. If a UWB node or tag goes out of range, the ranging thread may be destroyed and the UWB node or tag may be removed from the active tag stack. The WPAN network among anchors allows each thread to send uniquely identifying information including details about the ranging session to outside processing units. The specific implementation of these processes can vary from manufacturer to manufacturer.

The second view of FIG. 16 shows the communication structure between the nodes and anchors of the first view. In this particular scenario, multiple beaconing nodes exist around a single anchor. Each node sends information to the anchor to alert it of its presence. Each node is not actively ranging, but rather sending beacons or “beaconing” their information, similar to how a BLE fob communicates.

The main thread on an anchor begins receiving beaconing frames from specific nodes or tags. The main thread identifies the beaconing frames and adds each node or tag to a stack entry. The main thread then spawns a ranging thread with specific information composed in part from the stack entry. A scheduler on the anchor keeps a priority of ranging with each thread. A time splice is added to each thread to bring it into active ranging based on priority. The Main thread may have the highest priority and is brought to ranging more often than everything else. This allows the main thread to look for new tags. In a configuration where multiple cores exist on the anchor, multiple beacons from nodes or tags can be ranged simultaneously because multiple cores allow multiple threads to run simultaneously.

The process described allows us to find multiple beacons from nodes or tags and then range with them simultaneously and authenticate. As described, the system saves power and processing resources by limiting high-cost operations such as ranging to just those times where the operations are necessary. Similar scenarios are also contemplated where different configurations of nodes and anchors are possible. The example scenario implements some functions on the anchors, but those functions may be run on other components of the system.

### *UWB—Hand Gestures

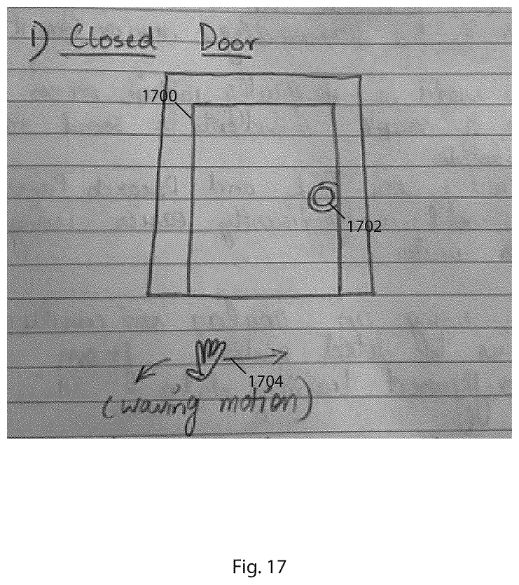

FIG. 17 is an illustration of a use case for a UWB enabled electronic lock system where a hand motion unlocks the UWB enabled electronic lock system. Door 1700 has electronic lock system 1702. A user initiates unlocking with hand motion 1704. UWB Radar may detect hand gestures such as swiping or other gestures. UWB Radar is able to detect hand gestures because of its ability to generate sub-nanosecond pulses at extremely high frequencies and reception of the reflected pulses. This enables the precise detection of various hand gestures including direction and speed of motion. Many motions can be detected such as, but not limited to, swiping vertically, swiping horizontally, and swiping diagonally. This approach allows a user to authenticate and securely open doors without any contact, thereby increasing accessibility and safety.

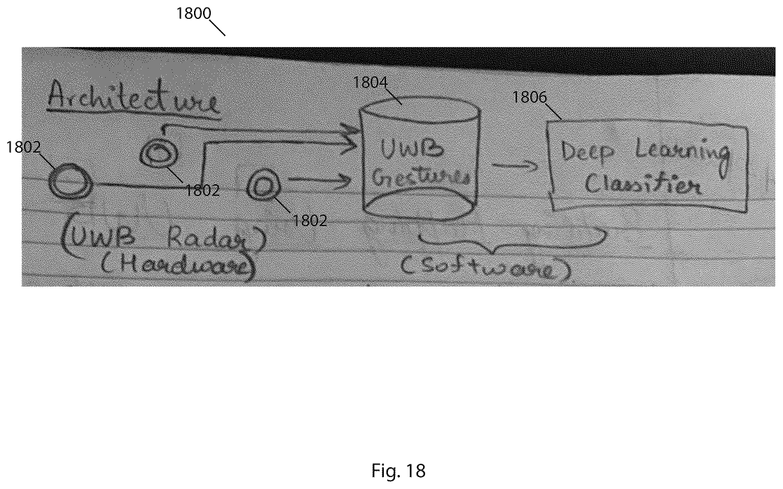

FIG. 18 is an illustration of the architecture of one possible implementation of a gesture detecting electronic lock system 1800. Electronic locks 1802 implement UWB Radar and may be networked together. A gesture recognition library 1804 may run remotely or may run on an individual lock. A deep learning classification system 1806 may interface to the gesture recognition library 1804 to adaptively classify gestures. The gesture recognition library 1804 may be either generated for the situational in situ, may comprise a previously generated library, or some combination of the two. The detection system may be implemented in an analog computer or may be implemented digitally. A UWB Transceiver emits and detects radio waves and is contained on a detection device which may include an electronic lock 1802. The computer may be trained to detect gestures using a mix of training and validation sets on various gestures captured using impulse radar sensors. The computer outputs a success or unsuccessful bit based on the gesture detected. This signal can then be used to gate authentication and subsequent lock control.

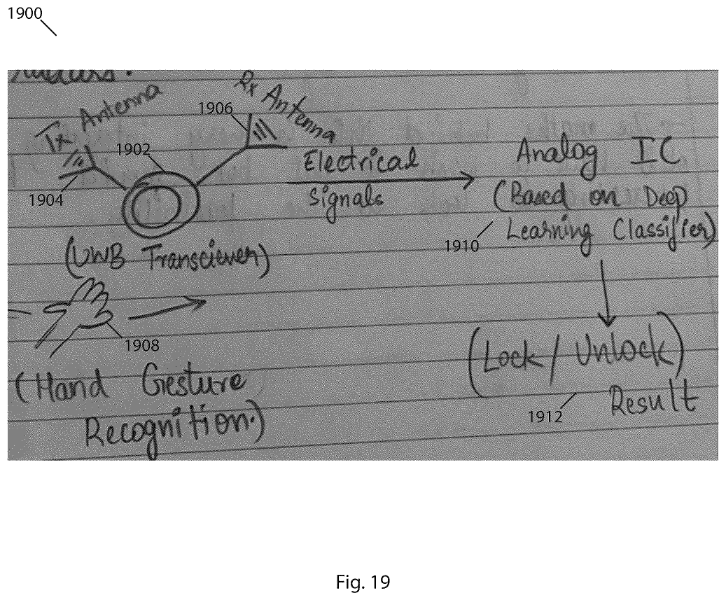

FIG. 19 is an illustration showing implementation details of a gesture based electronic lock control 1900. In this implementation, electronic lock 1902 contains transmit antenna 1904 and receive antenna 1906. In other architectures, transmit antenna 1904 may be situated remotely from receive antenna 1906 and neither needs to be specifically on the electronic lock 1902. Hand motion 1908 is registered as the change in signal over time transmitted from transmit antenna 1904 and received at receive antenna 1906. Motion may be measured either as subsequent positional changes or as Doppler shifts in received signals. During recognition, the electrical signals from the received signal are conveyed to a computer 1910 that decodes the signal and matches them against a database of gestures. When the signal matches, the result 1912 may be sent to the lock for further authentication and subsequent lock control.

### *UWB—Tailgating Detection

Tailgating is a problem in electronic access control where a second person follows a properly authorized first person through an access control space. The second person may not be authorized and hence should not be in the controlled area. The ability of UWB radar to identify objects in space, allows capabilities similar to Light Detection and Ranging (LiDAR) systems in a smaller and more cost-effective format. Tailgaing may be detected with UWB radar by identifying two adjacent waveforms when only a single credential is used to unlock the door. UWB radar is also able to give us the proximity of the two objects from the door, thereby helping us determine intent.

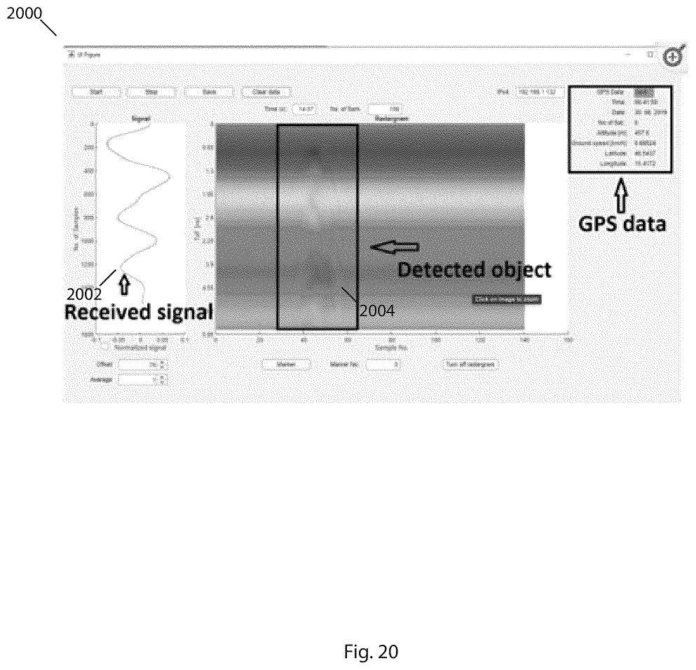

FIG. 20 is an illustration of the received signal from a UWB radar receiver when a single object passes through the UWB radar view. Received signal 2002 is graphed showing detected object 2004.

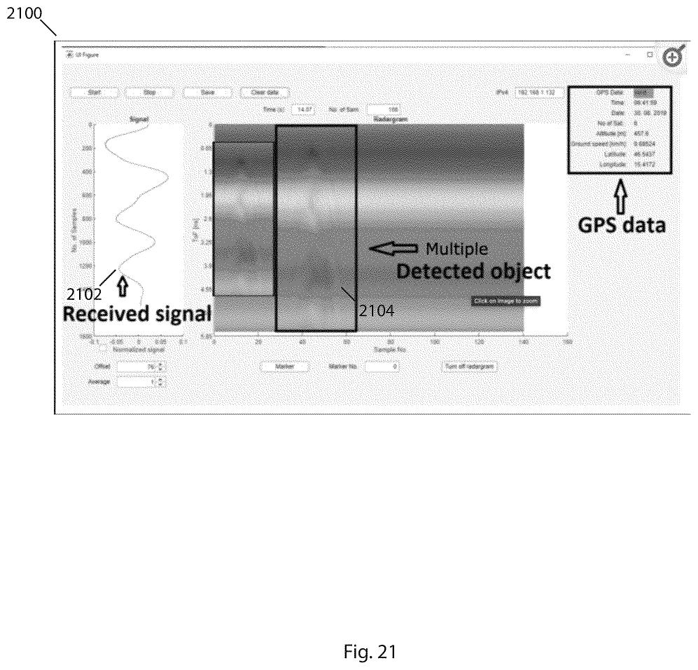

FIG. 21 is an illustration of the received signal from a UWB radar receiver when a single object passes through the UWB radar view. Received signal 2102 is graphed showing multiple detected objects 2104. A processor in an electronic lock system may identify the second object as a person tailgating a first person. Identification can be done through waveform matching, data base lookup, or other means known in the art. If only one credential was received, the electronic lock system can register and initiate a notification that there may be a tailgater attempting to circumvent the access control system.

All publications and patent applications mentioned in this specification are herein incorporated by reference to the same extent as if each individual publication or patent application was specifically and individually incorporated by reference.

The foregoing description of representative embodiments has been presented for purposes of illustration and description. It is not intended to be exhaustive or to limit the claims to the precise form disclosed, and modifications and variations are possible in light of the above teachings or may be acquired from practice. The embodiments were chosen and described in order to explain the principles of the claims and its practical embodiments to enable one skilled in the art to utilize the claims in various embodiments and with various modifications as are suited to the particular use contemplated.

It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying the principles of the invention. Similarly, it should be appreciated that any flow charts, flow diagrams, signal diagrams, system diagrams, codes, and the like represent various processes which may be substantially represented in computer-readable medium and so executed by a computer or processor, whether or not such computer or processor is explicitly shown. In addition, one or more flow diagrams were used herein. The use of flow diagrams is not intended to be limiting with respect to the order in which operations are performed.

The functions of the various elements shown in the drawings, including functional blocks labeled as “processors” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), non-volatile storage, or amalgamations of digital or analog logic. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function or software in any form, including, therefore, firmware, micro-code or the like, combined with appropriate circuitry for executing that software to perform the function. The invention as defined herein resides in the fact that the functionalities provided by the various recited means are combined and brought together in the manner which the operational descriptions call for. Applicant regards any means which can provide those functionalities as equivalent as those shown herein.

1. A method of waking an electronic device, comprising:
generating a unit of power in a power unit in an electronic device,
powering the electronic device with the unit of power,
measuring a physical characteristic of an output of the power unit in a power condition reading device wherein the physical characteristic reflects an external event that affected the output of the power unit, and
waking the electronic device based on the physical characteristic.

2. The method of claim 1 wherein the electronic device comprises an electronic lock.

3. The method of claim 1 wherein the power unit comprises a solar cell.

4. The method of claim 1 wherein the physical characteristic comprises one or more of a voltage level and a current level.

5. The method of claim 1 wherein the external event comprises one or more of a moving object, a fire alarm, a lightning storm, a change in an ambient lighting condition, and a person loitering near the electronic device.

6. The method of claim 1, further comprising:
activating a radio transceiver to detect a presence of an antenna near the electronic device, and
waking the electronic device based on the physical characteristic and the presence of the antenna.

7. The method of claim 1 wherein the unit of power is stored in an energy storage component.

8. The method of claim 1, further comprising:
selecting with a switch controlled by an output of a processor whether to power the electronic device with the unit of power or measuring the physical characteristic of the output of the power unit in the power condition reading device.

9. The method of claim 1 wherein a measurement of the physical characteristic is stored in a buffer of samples.

10. The method of claim 9, further comprising passing the buffer of samples through a low pass filter.

11. The method of claim 9, further comprising comparing the measurement of the physical characteristic to a mean value of the buffer of samples.

12. The method of claim 9, further comprising calculating a standard deviation for the buffer of samples and waking the electronic device when the standard deviation for the buffer of samples is outside a threshold.

13. The method of claim 9, further comprising applying a machine learning based filter to the buffer of samples to detect one or more of a person moving toward the electronic device, a person moving away from the electronic device, a person moving past the electronic device, a change in lighting near the device.

14. The method of claim 1, further comprising alerting a remote entity based on the physical characteristic.

15. An electronic device comprising:
a power unit configured for generating a unit of power and powering the electronic device with the unit of power,
a power condition reading device configured for measuring a physical characteristic of an output of the power unit in wherein the physical characteristic reflects an external event that affected the output of the power unit, and
a control unit configured for waking the electronic device based on the physical characteristic.

16. The electronic device of claim 15 wherein the electronic device comprises an electronic lock.

17. The electronic device of claim 15, further comprising:
a radio transceiver configured for activating to detect a presence of an antenna near the electronic device, and
the control unit further configured for waking the electronic device based on the physical characteristic and the presence of the antenna.

18. A non-transitory computer-readable medium having instructions stored thereon, which when executed by a processor, cause the processor to perform steps comprising:
generating a unit of power in a power unit in an electronic device,
powering the electronic device with the unit of power,
measuring a physical characteristic of an output of the power unit in a power condition reading device wherein the physical characteristic reflects an external event that affected the output of the power unit, and
waking the electronic device based on the physical characteristic.

19. The non-transitory computer-readable medium of claim 18, wherein a measurement of the physical characteristic is stored in a buffer of samples.

20. The non-transitory computer-readable medium of claim 19, wherein the instructions further cause the processor to perform steps comprising: applying a machine learning based filter to the buffer of samples to detect one or more of a person moving toward the electronic device, a person moving away from the electronic device, a person moving past the electronic device, a change in lighting near the device.
